(19) United States
(12) Patent Application Publication
(10) Pub. No.: US 2001/0032821 A1
(43) Pub. Date: Oct. 25, 2001

(54) Device for handling a solid support carrier for contaminants

(76) Inventors: Jean-Louis Drocourt, Yerres (FR); Pascal Yvon, Princeton, NJ (US); Anne-Claire Silvestri, Paris (FR); Veronique Lecocq, Maisons-Alfort (FR)

Correspondence Address: MERCHANT & GOULD PC, P.O. BOX 2903, MINNEAPOLIS, MN, 55402-0903, US

(21) Appl. No.: 09/725,966

(22) Filed: Nov. 29, 2000

(30) Foreign Application Priority Data
Nov. 29, 1999 (FR) 9915030

(51) Int. Cl. B01D 17/00

(52) U.S. Cl. 210/767; 210/198.1; 210/541

(57) ABSTRACT

The present invention relates to a mounting device 1 of a support carrier 5, notably for a device handling at least one support carrier, wherein this support has a said “active” portion for contaminants. It includes a base plate 1 comprising a through aperture with dimensions substantially or larger than the dimensions of said active portion, first means 15a, 15b able to removably fix said support carrier 5, wherein said active portion of the support is positioned facing said aperture on a first side 12 of said base plate, and second means 16a, 16b able to fix an auxiliary element 6, 7 against the other face or the support carrier, wherein the support carrier is doubly fixed relatively to said base plate 1.

It also relates to a container adapted to such devices as well as to filtration and/or activation units including such devices.

The present invention relates to devices for handling solid supports like filtering membranes for detecting and notably counting contaminants.

Fast qualitative and/or quantitative analysis of the presence of contaminants, like microorganisms, is required for notably carrying out sterility tests on fluids, and notably on filterable fluids.

Thus, the detection and analysis of particles, whether alive or not, normally present or possibly contained as contaminants, in liquid or gaseous fluids, foodstuffs, pharmaceutical, biological, cosmetic products or sanitary products, as well as the monitoring of fermentation processes generally include a step for depositing particles or, a support and optical analysis of the support's surface, for example by scanning it. Patent EP333561 in the name of CHEMUNEX describes an apparatus for detecting living, dead or inorganic particles, providing detection and an immediate count of particles, directly on a solid support. A solubilization of the sample to be analyzed is usually carried out, with a filtration step in mind. In the fluid sample filtration step, particles may be deposited on a filtering support through which flows the fluid to be analyzed and the support retains at its surface the particles, the nature and number of which are to be determined. Following this filtration step, one or more processing steps are performed on the sample deposited on this filtering support, such as a step for activating and/or growing microorganisms during which the latter, present on the filtering support, are placed in the presence of nutrients, for example by using a pad impregnated with a nutrient solution; then a labelling step during which the microorganisms are labelled by placing the filtering support in the presence of a pad impregnated with a labelling solution. A subsequent step consists in analyzing the surface by laser scanning. For this purpose, a SPS (Solid Phase Scanning) device may be used as described in document EP333561.

Presently, in order to be successful with such a method, an operator performs the following steps which require that the filtering membrane be handled several times:

lay down the filtering membrane on a sintered glass disc mounted on a vacuum manifold, install a funnel for receiving the fluid sample, a determined amount of which is caused to cross the membrane and sintered glass by suction; contaminants such as microorganisms, settle on the membrane when the sample is sucked in through the support and sintered glass, and then the funnel is removed;

with tweezers, pick up the filtering membrane in order to put it into contact with a cellulose pad impregnated with nutrients, whereby contact is maintained for a determined lapse of time in order to perform the activation step at a determined temperature;

with tweezers, transfer the filtering membrane on a second pad impregnated with a labelling solution, whereby contact is maintained for a determined lapse of time in order to perform the labelling step;

with tweezers, transfer the filtering membrane onto the rack of the laser scanning detection apparatus, on which may be deposited a humectant membrane beforehand;

optionally transfer the membrane positioned on the rack, for microscopical examination.

During each of these steps, which demands skill and experience on the part of the operator, risks of contamination and deterioration of the filtering membrane cannot be ruled out. These contaminations and deteriorations may occur by contact with the tweezers or the operator's fingers. In addition to tearings and contaminations of the membrane, mechanical deformations of the membrane which endanger the subsequent detection operations by laser scanning for which observance of flatness with an accuracy of the order of 10 microns is required, should notably be avoided.

The object of the invention is to provide devices for handling a solid support of contaminants which enable one step or successive steps to be performed for fixing or depositing the contaminants and for processing the solid support prior to its analysis, by avoiding contaminations and damages to the support of contaminants during the fixing or depositing steps, processing operation(s) and read-out. Advantageously, these devices provide standardization of analysis procedures

Thus, the present invention relates to a device for mounting a support carrier, notably for a device handling at least one support carrier, wherein said support carrier comprises an area able to receive a said “active” portion of a support for contaminants, characterized in that it includes a base plate comprising a through aperture of dimensions substantially identical or larger than the dimensions of said active portion, first means able to removably fix said support carrier so that said active portion of the support is positioned facing said aperture on a first side of said base plate, and second means able to fix an auxiliary element against the side of the support carrier opposite to said first side of the base plate, so that said support carrier is doubly fixed relatively to said base plate.

Thus, first means borne by the base plate are provided for locking, in a position substantially parallel to the plate on its lower face, and unlocking, a first substantially flat element formed by the support carrier, and second means borne by the base for locking, in a position substantially parallel to the plate, and unlocking, a second substantially flat auxiliary element, superimposable on the first element on its lower face.

Said second fixing means are laid out so as to place, together with said auxiliary element, said first means in a locking position precluding any movement of said support carrier. The first fixing means comprise at least two clips made of an elastic material, positioned substantially facing each other so that they may cooperate with two edges of said support carrier. The second fixing means comprise at least two clips made of an elastic material, positioned substantially facing each other, so that they may cooperate with two edges of said auxiliary element. The clips comprise at their free ends a fixing nib or supporting prominence wherein the distance between the nib and the surface of the plate facing the nib is substantially equal to the thickness of said auxiliary element and/or said support carrier.

The base plate on its face opposite to said first side of the base plate, may further include means laid out so as to allow a container to be positioned sealably, facing said active portion of the support, this for bringing a fluid to the level of the support.

Moreover, the base plate may include positioning means comprising a sleeve substantially delimiting, on the side opposite to said support, the periphery of the aperture and including, in a selected location of its internal surface, near the active area, at least a first portion protruding inwardly, and/or may extend at least partly inside the aperture by a second portion protruding inwardly.

In a particular embodiment, the first protruding portion is a toric prominence and/or the second protruding portion is substantially circular. In a particular embodiment, this first or second protruding portion extends over the whole periphery of the aperture or of the sleeve.

According to another aspect of the invention, the latter relates to a container for a device handling a support for contaminants including at least an upper portion forming a tank and a lower portion including an output port with a shape matched to that of the active area and including a recess for cooperating with a protruding portion, and stop, of the base plate.

According to another aspect of the invention, the latter relates to a filtration plate of a device for handling a support for contaminants. This auxiliary element is made up of a substantially flat base with dimensions able to cooperate with said second fixing means.

This auxiliary element may include a sleeve and/or a positioning sleeve set up at the active area, on its lower and/or upper face, respectively.

When the auxiliary element is a filtration support plate, the latter is made up of a substantially flat base with dimensions able to cooperate with said second locking means, provided with, a perforated filtration surface with dimensions substantially identical or larger than the dimensions of the active area of the solid support.

The auxiliary element may also be a pad carrier plate of a device for handling a support for contaminants, including a support according to the invention. It is then provided on its upper surface with a sleeve, preferably encircling it tightly, with dimensions substantially equal to those of the active area and with a thickness substantially identical to that of a pad.

This pad is for allowing close contact between the support and a liquid with which it is impregnated, for example, a reagent required for the incubation. A pad may be impregnated by depositing a possibly predetermined amount of reagent thereon before applying the fixed support carrier onto the base plate.

In a preferred embodiment, the whole incubation set, including fixed base plate, support carrier, and pad carrier plate may also be formed before injecting a possibly predetermined amount of liquid therein. The present invention also concerns a process for treating a contaminant of a sample, said contaminant being fixed or deposited on a support comprising a lower surface, wherein the contaminant is incubated or labelled by contacting of a pad fed with nutrients and/or labelling solution with said lower surface or said support, in which said pad is fed with said nutients or labelling solution after placing said inferior surface on said pad.

According to another aspect of the invention, the latter relates to a filtration and/or activation unit including at least one mounting device according to the invention and at least one of the items selected from a support carrier, a container, a filtration plate, a pad carrier plate and a lid. In this preferred embodiment, wherein liquid is injected after fixing the support between the pad and the pad carrier plate on one side and the base plate on the other, means may be provided for injecting liquid into the pad. One of the functions of the pad carrier base plate is then to allow drainage, suction by the pad and saturation of the pad, without air being trapped between the pad and the support (claims 17, 18).

An injection port, possibly associated with a port for air leaks or degassing, for example located at the opposite of the injection port, may be provided, which crosses through the pad plate's thickness, connects the outside with the provided cavity for receiving the pad and the liquid, and it enables the liquid to be injected into the pad with the help of a syringe.

Moreover, in a more preferred embodiment, the pad carrier plate includes injection means including an input channel for the liquid and a configuration of the pad carrier plate's area facing the active area selected for distributing the instilled liquid.

For example, in the cavity formed on the pad carrier plate, which receives the pad and the liquid, ribs may be provided for supporting the pad. The geometry should be selected so that, upon injection, impregnation should be fast and without any backflow or overflow, wherein flow is the most laminar as possible.

In this case, the base plate includes, facing this chimney, a through aperture for giving access to this chimney, with a pipette, a syringe or any other means for injecting the liquid into the pad. This aperture also functions as a foolproof device.

Thus, for example, during filtration, the unit includes a container, a base plate, a support carrier and filtration plate. After filtration, the unit includes a lid, the base plate, a support carrier and a pad carrier plate.

The devices according to the invention are for handling, transporting and storing, before or after their use, supports for contaminants, with their analysis in mind, without the aforementioned risks, i.e. under conditions providing security and regularity in the analyses, whereby the result of the analyses does not depend any longer or depends much less on the know-how or skill of the operator.

In the present description, contaminants may be microorganisms, bacteria, living cells or not, as for the aforementioned method. They may also be hair, dust, remnants, fibers, which may be collected like microorganisms on a filtering support or through decantation. The contaminants may also be fluids in a solution, like any chemical substance whose presence is likely to be subsequently detected on or in a solid support. Thus, a contaminant, in the present application, is any substance, particle, microorganism which may be detected either on or even in a solid support, to the extent that this substance may be fixed, impregnated, deposited or set, and/or changes the characteristics of the solid support.

The devices of the invention are intended to be implemented in a method for detecting contaminants, wherein the detection step is subsequent to a step for fixing the contaminants on or in a support. According to the invention, the solid support is not limited to filtering membranes and the detection method is not limited to methods implementing activation and labelling, as described above for example. Thus, positive filtra-tion may be contemplated as well as deposition steps without filtration, by decantation, for example, or impregnation.

The base plate or mounting plate is for bearing the support carrier, and during the various steps for processing the support, before and after its analysis, for bearing a container or tank with fluid to be analyzed or a container or tank with marker fluid or nutrient, and/or successively a filtration plate or one or several pad carrier plates. It may also be for cooperating, in a subsequent step, with the rack of an optical analyzer or “read-out” apparatus upon depositing the solid support on the rack. It is also for storing solid supports where contaminants are fixed. Finally, it is for providing a sealed fluid communication between the tank, the solid support and the filtration plate, during the filtration or deposition step.

By active portion of the support, it is meant the portion of the support which comes into contact with the fluid to be analyzed on the one hand, with possible nutrients, activators, markers and developers for activating, developing and generally making the contaminants analyzable by the read-out apparatus on the other hand, whereby this active portion is subject of the analysis or read-out. The zone in regard to this active portion is called active zone for each of the devices herein described.

In a particular embodiment described hereafter, the active zone substantially coincides with the internal diameter of the end of the tank, a funnel for example.

In the particular case of the implementation described in patent EP 333561, this solid support is a filtering membrane. These membranes are known as “Cyclo-black” and marketed by the Whatman company. These are membranes based on polyethylene terephthalate, with a thickness usually of the order of 23 microns, a porosity of the order of 0.1 to a few microns. Also, “Teflon” membranes, metal membranes, usual membranes of the polycarbonate, cellulose ester or cellulose nitrate type and generally any membrane or pad capable of fixing the contaminants to be detected or analyzed on its surface or its mass, may be considered according to the invention. If the contaminants are deposited through decantation, non-filtering supports in synthetic, metal or glass material may be considered.

The solid support, for example the filtering membrane is definitively positioned or not on a substantially flat support carrier, perforated with an aperture leaving the active portion of the solid support, free and accessible to the fluid. Such supports are notably described in the patent document FR 2 752 172 filed on behalf of CHEMUNEX.

The support carrier is for supporting the solid support during the various steps and for cooperating with the mounting plate and is to be fixed thereon removably. The aperture of the mounting plate is positioned substantially facing the active area of the solid support. It may have the same dimensions or dimensions slightly larger than those of the active area. Moreover, the solid support is preferably held through its support in a position substantially parallel to the mounting plate.

The solid support is firmly secured to the support carrier by mechanical or chemical means. Generally, the solid support is substantially flat and may have a larger surface than the active area; the contours of the active portion allow the solid support to be secured to its periphery with the support carrier. Thus, the contours may be stuck to the support carrier by glue or by a double-face adhesive, or further held under stress between two portions forming a frame of the support carrier, wherein one portion fits exactly into the other and the solid support is blocked therein by clamping or friction. Fixing the solid support by ultrasound or laser welding, for example, to the support carrier may also be considered, The solid support may also be firmly secured to the support carrier by over moulding, by positioning it at the bottom of the mould before injecting the plastic of the support carrier, selected for its lack of moulding shrinkage. Advantageously, the support carrier may be made of a material with an expansion coefficient similar to that of the membrane. Actually, certain labelling or activation steps are performed at temperatures of the order of 20° to more than 40° C., very different from the temperature for other steps, for example scanner read-out (about 8° C). Certain steps may require temperatures of the order of 0° C. By selecting a similar expansion coefficient, risks of tearing or stretching of the membrane may be avoided during the various steps and handling operations where observance of flatness may be essential for good performance of the analysis. Thus, for polyethylene terephthalate membranes known as “mylar”, polyethylene terephthalate, polybutadiene terephthalate, mixtures of these polymers and also mixtures of these polymers with glass fibers or “Velox” may be selected for the support carrier.

Moreover, the mounting plate is for bearing, either removably or not, a fluid tank container used upon depositing the contaminants on or in the active area of the solid support.

The fluid tank container is for containing an optionally predetermined amount of fluid to be analyzed which is expected to flow through the solid support in order to deposit the contaminants to be analyzed. This container may assume the shape of a funnel with a predetermined volume, graduated if possible, whereby the shape is selected for complete flow of the product during filtration. In this respect, the angles are selected preferably between 0 and 90°, preferably between 0 and 80°, preferably of the order of 70°, so that the liquid product does not settle in the conical portion connecting the tank to the tapered portion of the container.

As for the material, plastic containers compatible with mass production, for example by moulding or blowing may be selected. They may also be selected so as to be transparent so that the operator may perform a visual check of the level of the contents and of the total flow of the fluid through the filter, and a usual check of the condition of the solid support. Moreover, it might be important to select a material which prevents salting out of particular remnants or contaminants, notably chemical contaminants during its use. According to the implemented detection system, the material may be selected so as to be inert with respect to the microorganisms and in particular to prevent absorption of these microorganisms. Polypropylene may be selected for Implementing this particular method, as described in detail above.

The lower portion of the funnel, mounted on the mounting plate, may be provided so as to cooperate with the mounting plate so that, during filtration, the junction between the end of the funnel and the solid support does not have any leakage. Alternatively, this junction may be provided for a ring forming a more flexible seal, which allows the flatness defects to be compensated upon assembly and filtration.

The low end of the funnel engages and is accommodated in the aperture of the mounting plate facing the active area of the solid support. In a particular embodiment, the mounting plate includes a hollow cylindrical sleeve with a section substantially similar to that of the external perimeter of the lower portion of the funnel. This sleeve is set up on he upper face of the base plate. However, other holding means for the funnel in sealed contact with the solid support may be provided for fulfilling the function of this holding sleeve.

During the filtration step, the mounting plate further cooperates with a filtration support plate for a vacuum pump, or allows flow in the case of positive filtration, positioned on its lower face and provided with a filtration plate positioned facing the active area, i.e., facing the aperture of the mounting plate. This filtration support for a vacuum pump is e.g. intended to support the filtration unit during filtration on the vacuum manifold while maintaining the flatness of the solid support. This solid support is held and sandwiched between the filtration liquid and the filtration plate, optionally provided with a pad. To perform its functions, the filtration support, facing the active area of the solid support, may include as filtration plate, a perforated area through which suction may be carried out. The holes are provided for promoting flows of liquid. This perforated area, on the lower face of the filtration support, is facing a port with a section substantially similar to that of the vacuum pump. Moreover, on its upper face, a recess may be provided for a pad, for example a cellulose pad, preferably inert, which isolates the perforated portion from the filtration plate of the solid support itself in order to prevent deformations or tearings of the solid support in the case of normal or accidental suction, which, by is nature, would deform, deteriorate or generally impair flatness and integrity of the solid support.

As for the material used for the filtration support for the vacuum pump, after taking into account manufacturing constraints by moulding and stiffness and robustness constraints, a plastic of the high density polyethylene type may be selected.

As for the shape of the filtration plate which is perforated, the latter may be pierced or provided with holes, wherein the shape of the holes may depend on the applied vacuum pressure, and notably on the medium's viscosity.

A first function of the filtration support plate is the capability of mounting the filtration unit on the extension of a vacuum manifold. Moreover, a second function of the filtration plate consists in supporting the solid support during suction, which may be achieved by a holed or netted shape of the filtration plate for a vacuum pump which is located facing the solid support and its active area.

In order to fulfil the supporting function, the cellulose pad may have a height which matches the thickness of the support carrier or even the thickness of the lower portion of the support carrier, if the latter includes two portions.

Upon suction, tightness of the device may also be provided by the cellulose pad, through its elasticity, the end of the funnel abutting against the periphery of the active area on the upper face of the solid support, the other face of which comes into contact with the pad positioned on the filtration plate.

A sleeve which allows the filtration unit to be positioned, mounted on the extension of a vacuum manifold, may be positioned on the lower face of the filtration support plate. However, other means for firmly securing the filtration plate to the vacuum manifold may be provided as usual, notably depending on the shape of the vacuum pump's extension.

In the layout of the filtration unit, the filtration support plate for a vacuum pump now holds and sandwiches the solid support and its support carrier between its upper face and the lower face of the mounting plate, wherein the filtration plate is removably secured to the mounting plate.

In a particular embodiment, more than one active area may be provided, for example two of them; the base plate then includes two apertures, the filtration support plate also, and the container may be provided so as to include two output ports, provided for cooperating with both apertures of the base plate.

Moreover, the mounting plate is for removably and successively bearing one or several pad carrier plates. These pads are impregnated with fluids required for the activation and labelling steps.

Thus, during the activation and/or labelling steps, the mounting plate is for holding and maintaining the support carrier and essentially these solid supports in a stable flat and accessible position, on the lower face of the solid support and in its active area or in a slightly more extended area, so as to be impregnated by an activator or a labelling agent as usual, from a pad loaded for this purpose. The pad support has the function of maintaining such a pad in contact with the active area, the pads preferably have substantially the same dimensions as the active area of the solid support or a larger dimension. This contacting may be achieved by the fact that the pad support is essentially flat and located substantially parallel to the lower surface of the mounting plate and it essentially sandwiches the solid support and its support carrier between its upper face and the lower face of the mounting plate.

Thus, in the layout of the labelling unit, the pad support plate therefore sandwiches and holds the solid support and optionally its support carrier between its upper face and the lower face of the mounting plate, wherein the pad support is removably secured to the mounting plate.

In order to improve stiffness of this sandwich and bearing of the support, notably during filtration, stops which keep the distance between the filtration plate constant, may be provided protruding over either one of these facing plates. These stops prevent the funnel from being pushed back outwards when the whole is fastened by clips: funnel/base plate/support plate on the filtration plate.

As for the materials provided for the pad supports, they may be made of mouldable plastic. At the active area or in a slightly more extended region, the thickness of the pad support may be reduced in order to obtain good thermal conductivity, indeed, during certain activation steps for labelling, it is necessary to put the labelling activation unit in an incubator, wherein calories are supplied by heating pads with a surface area substantially similar to that of the active area or larger than the latter. A recess of the same shape as the incubator's pad may be provided on the lower face and a recess or a sleeve may be provided on its upper face so as to form a cavity for the pad. The pad carriers may also be made in metal.

Further, adjustable lids on the sleeves of the mounting plates may be provided, which notably enable the mounting plates to be stored where the support carrier and a pad carrier plate are locked, or for performing activation or labelling steps without contaminating the solid support. These lids may be made of plastic.

Thus, generally, selection of materials takes into account the manufacturing method for the various items, the heat treatments which they may undergo and their production costs.

Finally, device adjustments which would be expected for them to be handled automatically, and which might cooperate with robot handling means, are not described herein.

The principle for using the mounting plate was described and illustrated in reference to a method where a filtration step, an activation step and a labelling step take place before read-out. However double locking and exclusive unlocking of the support carrier may be used in other methods and support handling operations. For example, deposition achieved through decantation does not require any filtration plate, but requires at least a funnel and possibly not an activation pad, for example when the activation step is not required.

Moreover, in the detailed embodiment hereafter, the locking-unlocking method for the support carrier and the auxiliary element is of the clip type. However, other embodiments are possible. For example, two double slide rails may be borne by the base plate on its lower face, wherein the support carrier comes into position by moving parallel to the base plate in a first slide rail, the auxiliary element coming into position beneath the support carrier by moving in a second slide rail, whereby means are provided on the auxiliary element for blocking the support carrier in the suitable position, facing the active area.

The invention is described in more detail hereafter and other advantages of the latter will become apparent upon reading the detailed description of particular embodiments with reference to the appended drawings wherein:

FIG. 1 is a perspective view of a dismantled filtration unit;

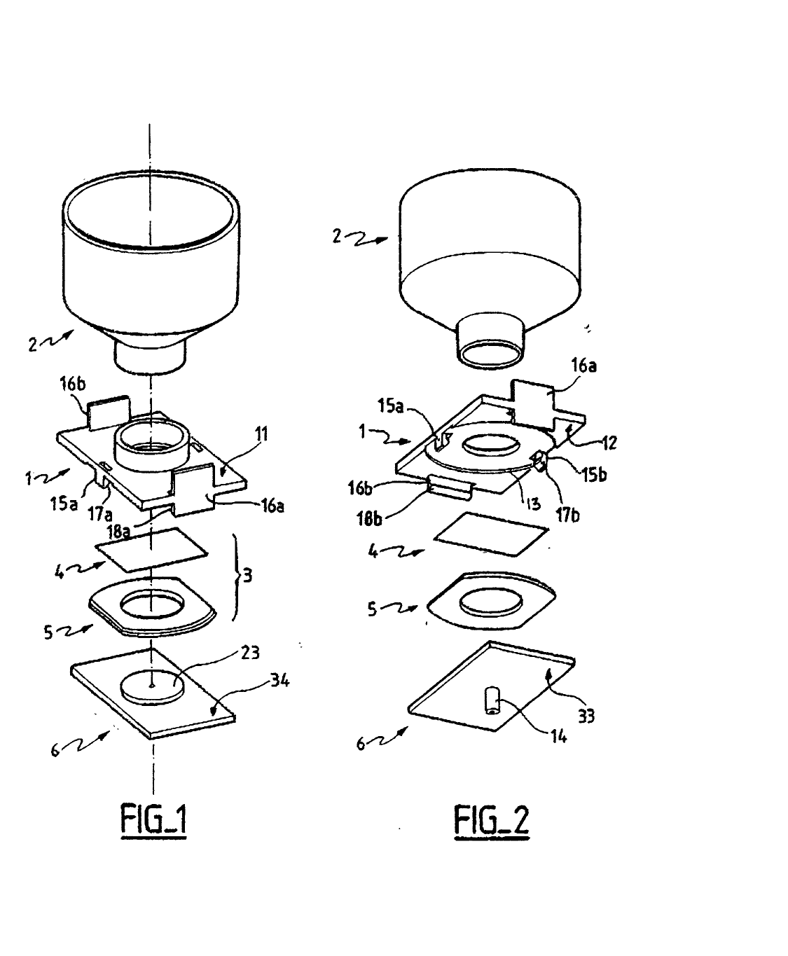

FIG. 2 is another perspective view of a dismantled filtration unit;

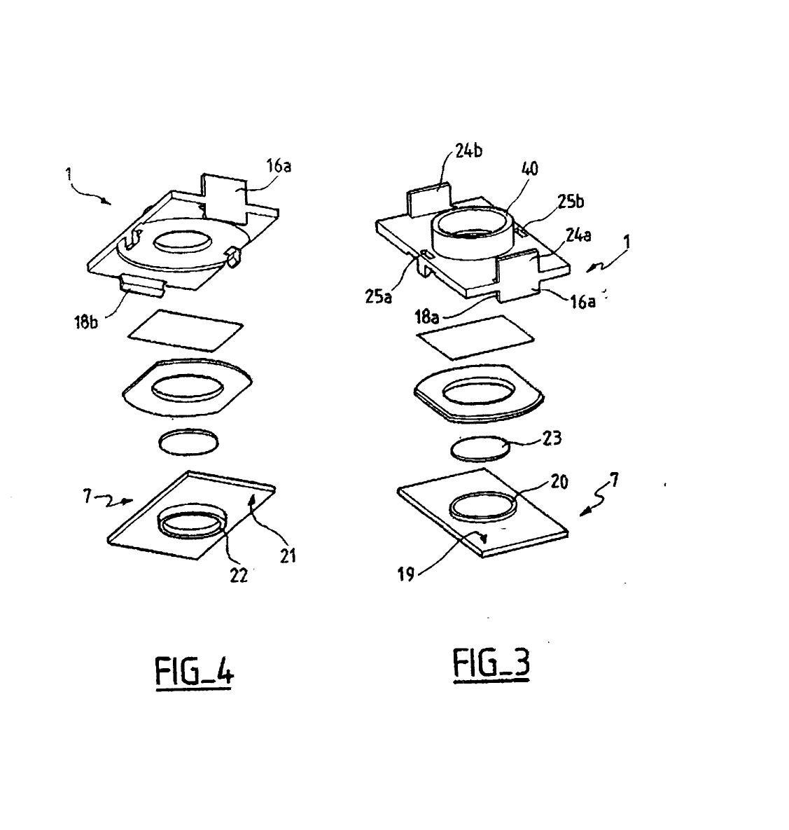

FIG. 3 is a perspective view of a dismantled activation or labelling unit;

FIG. 4 is another perspective view of a dismantled activation or labelling unit;

FIG. 5 is a perspective view of a dismantled read-out unit;

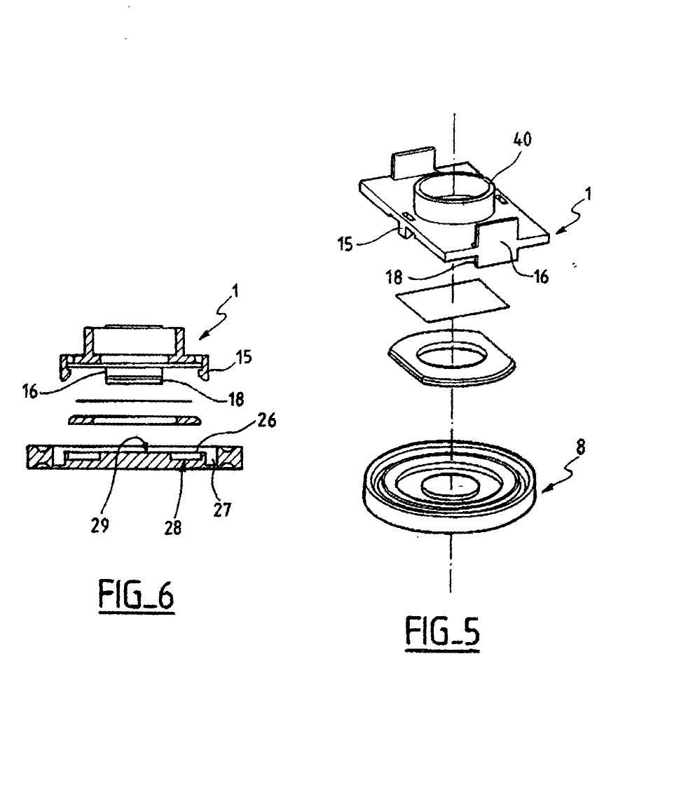

FIG. 6 is a sectional view of the read-out unit in FIG. 5 in a vertical plane;

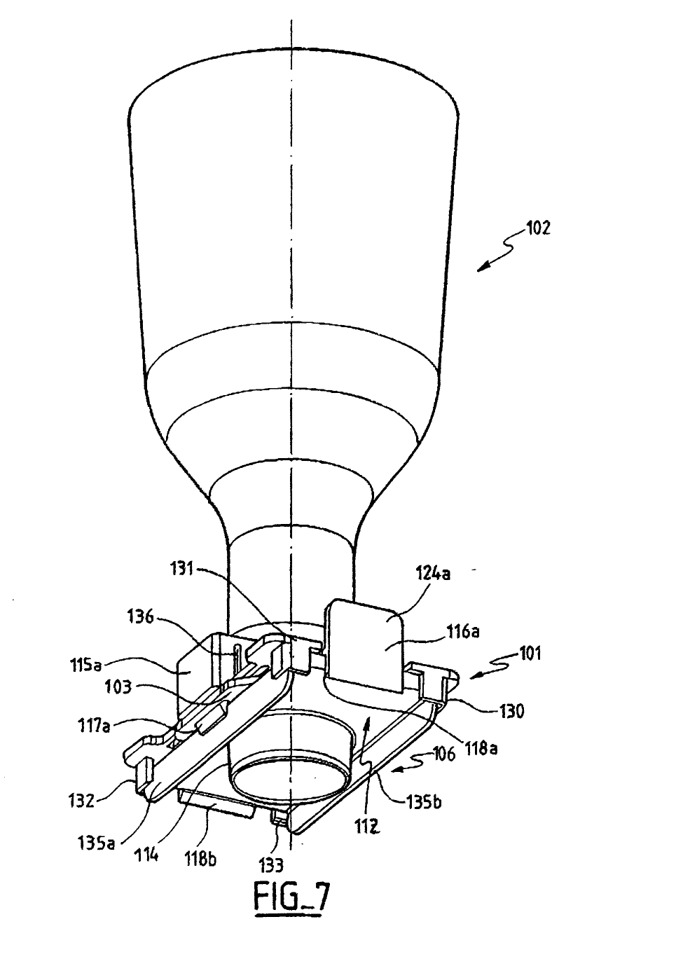

FIG. 7 is a perspective view of another filtration unit mounted on a mounting plate other than that in FIGS. 1-6;

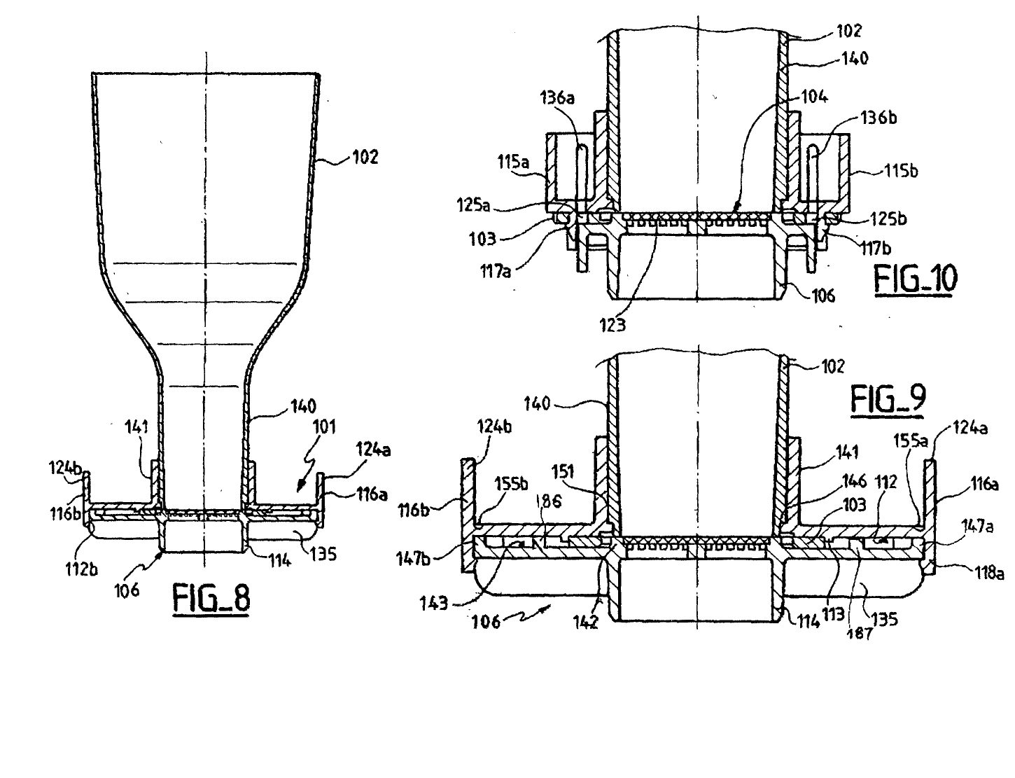

FIG. 8 is a sectional view of the mounted filtration unit of FIG. 7 in a vertical plane;

FIG. 9 is an enlarged partial sectional view of the mounted filtration unit of FIG. 7 in the same vertical plane;

FIG. 10 is a partial sectional view of the mounted filtration unit of FIG. 7 in another vertical plane;

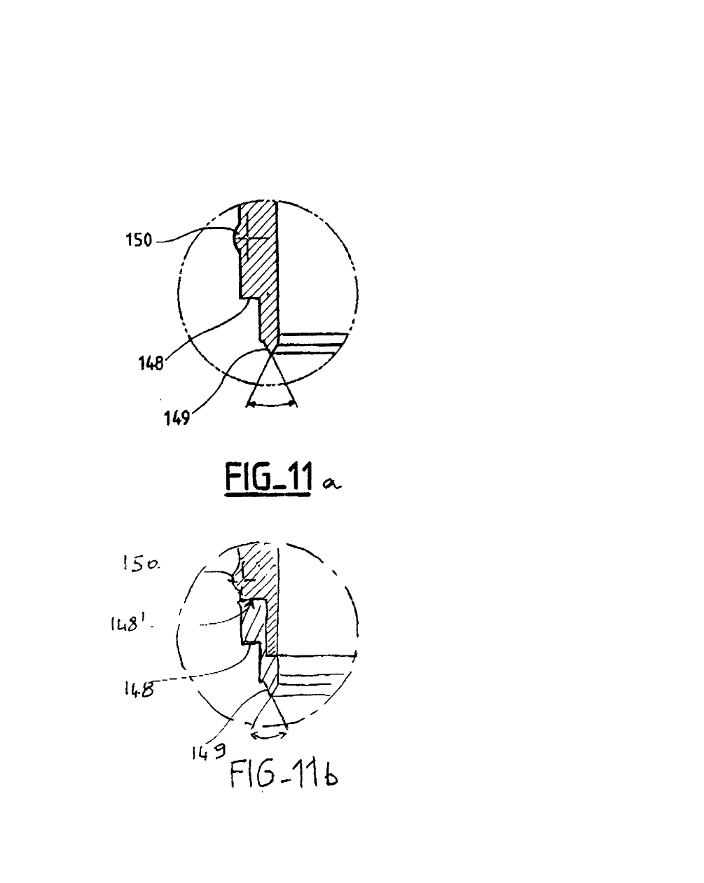

FIG. 11a is a partial sectional view of the end of a container from the filtration unit of FIG. 7 in a vertical plane; FIG. 11b is a partial view of another embodiment of said end.

FIG. 12 is a perspective view of an activation or labelling unit mounted on the same mounting plate as in FIG. 7;

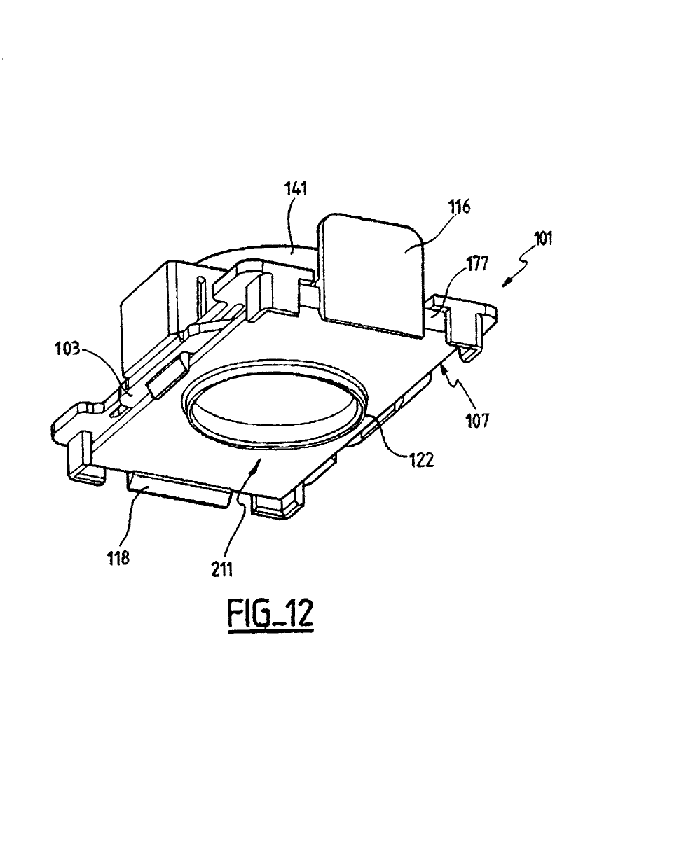

FIG. 13 is a sectional view of the mounted activation or labelling unit of FIG. 12 in a vertical plane;

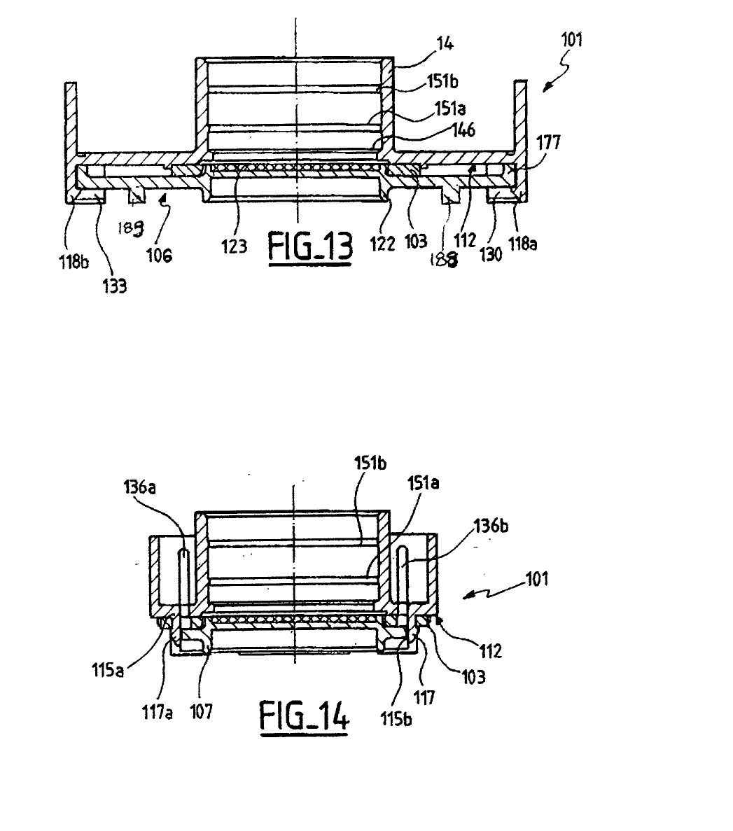

FIG. 14 is a sectional view of the mounted activation or labelling unit of FIG. 12 in a vertical plane;

FIG. 15 is a perspective view of a mounting plate;

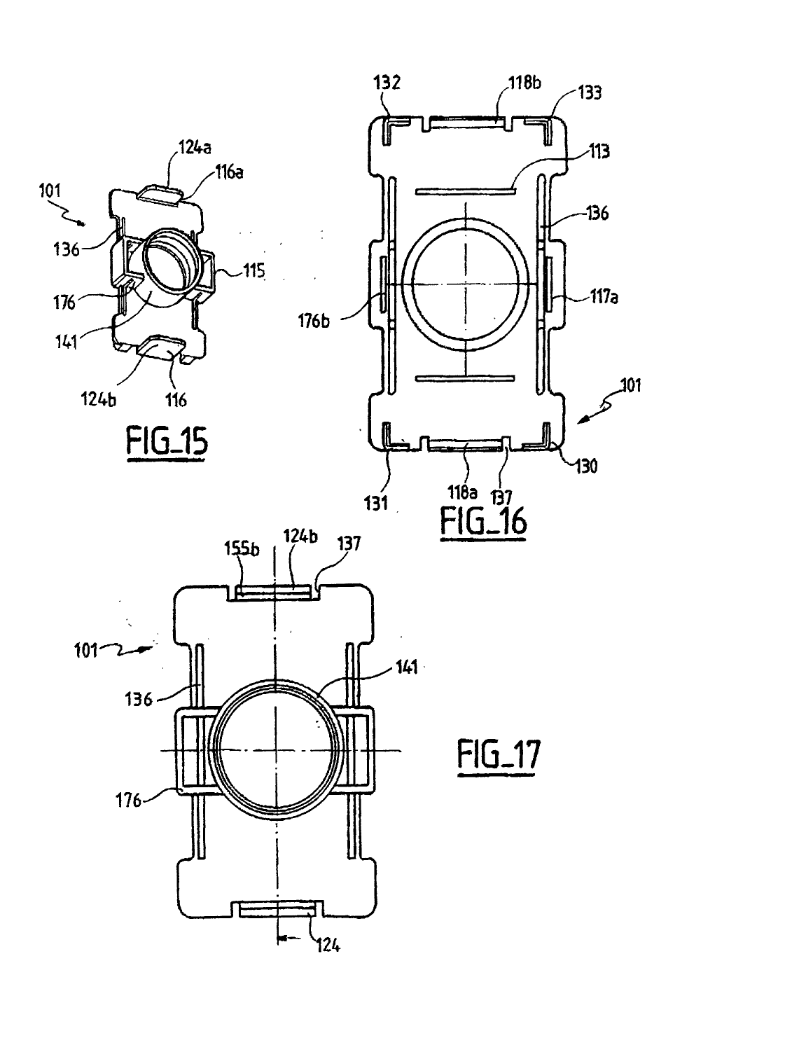

FIGS. 16 and 17 are views of the mounting plate from FIGS. 8, 9, 10 and 15;

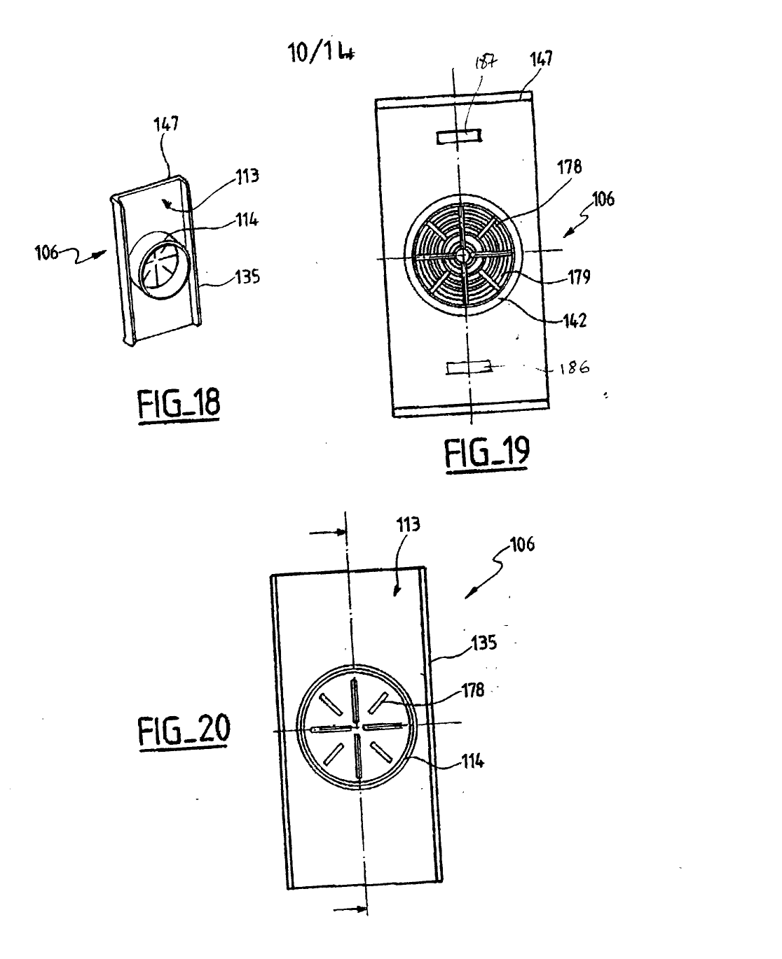

FIG. 18 is a perspective view of a filtration plate;

FIGS. 19 and 20 are views of the filtration unit from FIGS. 8, 9, 10 and 18;

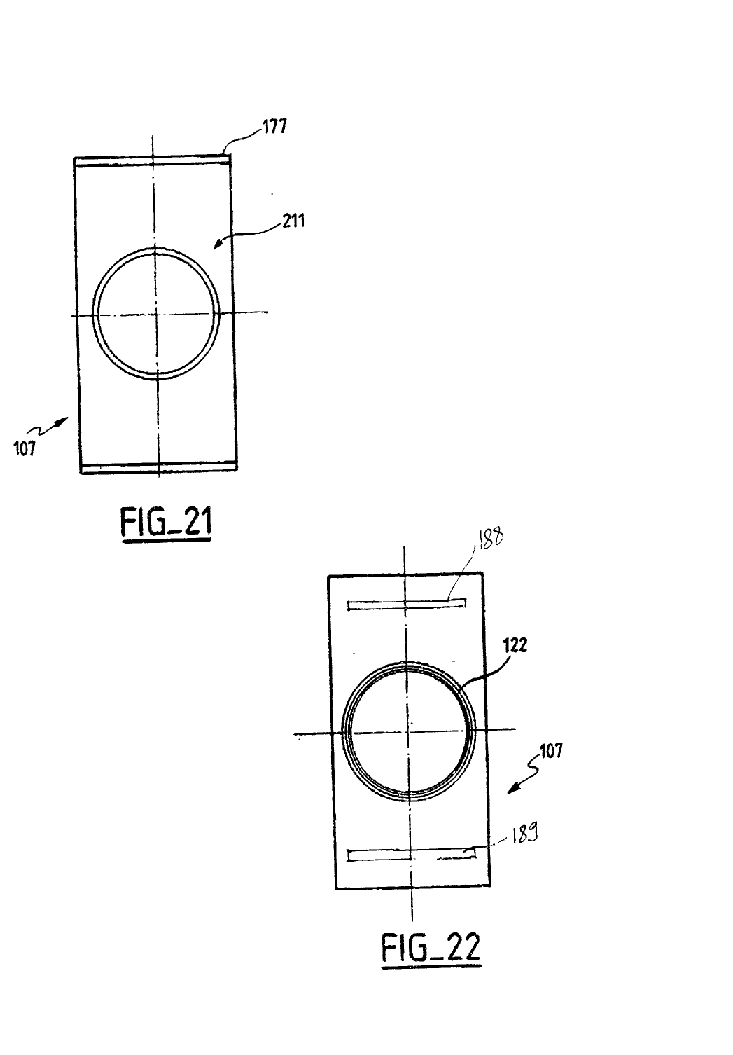

FIGS. 21 and 22 are views of the pad carrier-plate from FIGS. 12, 13 and 14;

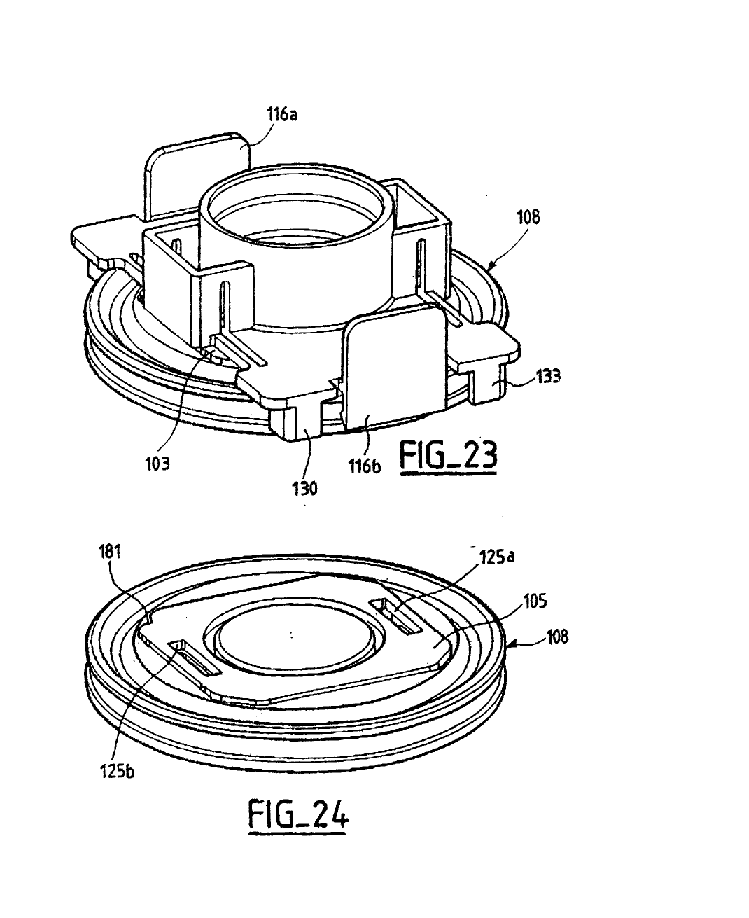

FIGS. 23 and 24 are perspective views of the read-out unit from FIG. 5, before and after unlocking the support carrier, respectively;

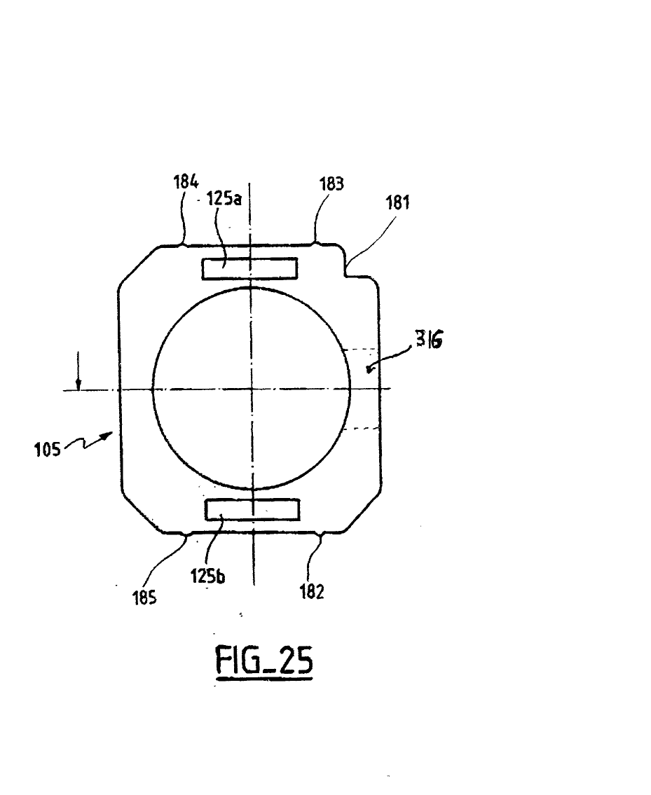

FIG. 25 is a top view of a support carrier as used in units from FIGS. 7, 8 and 9, notably.

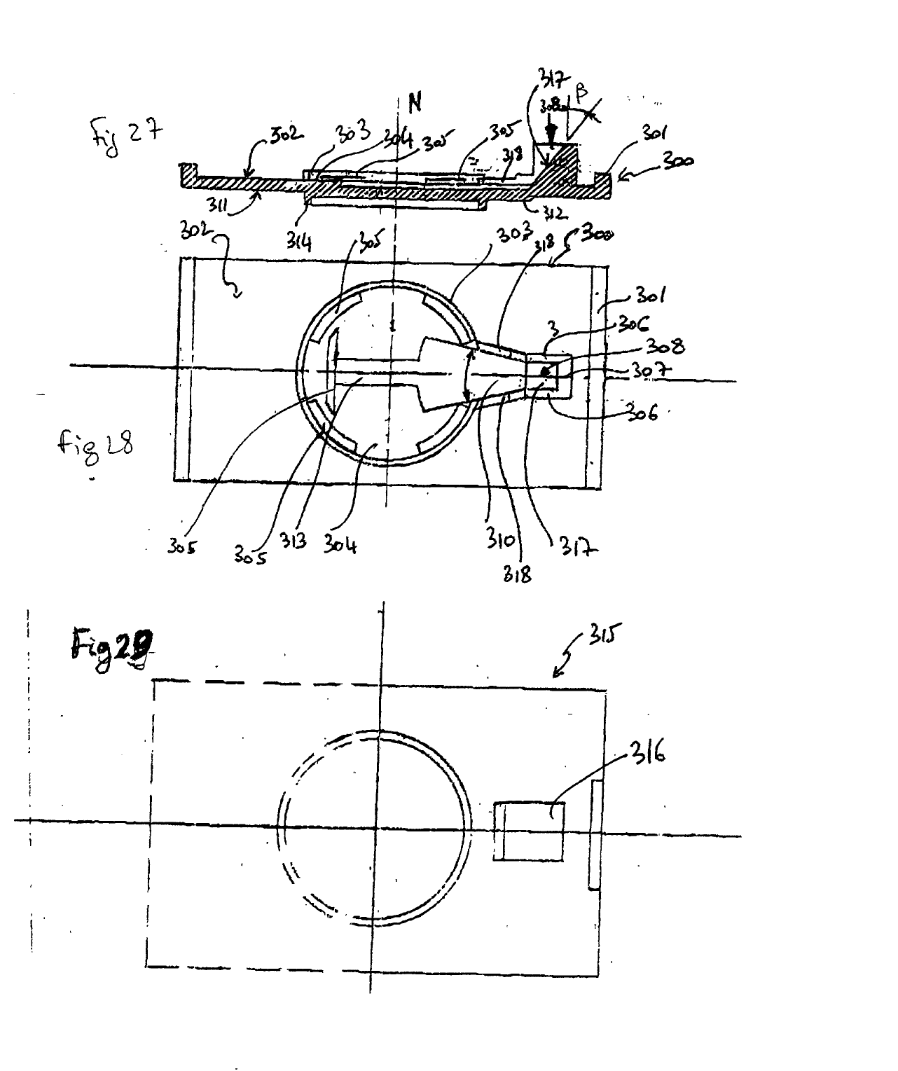

FIGS. 26 and 27 are views of the pad carrier plate from the embodiment for which the liquid is injected after fastening the clips.

FIG. 28 illustrates a partial top view of the base plate including a through aperture corresponding to the use of the pad carrier plate of FIGS. 26 and 27.

FIG. 1 illustrates a first embodiment of a device according to the invention, the different components of a complete device for filtration appear schematically in an exploded perspective view, thus, the mounting plate 1 is axially mounted with a container 2 on the side of the upper face 11 of the mounting plate 1. On the other side of the mounting plate 1, are located support 4 and frame 5 of the support carrier 3. Generally, support 4 and the frame of the support carrier form a support carrier unit designated hereafter by support carrier 5. In FIG. 1, a filtration plate 6 also appears, located beneath support carrier 5. A cellulose pad 23 which covers the filtration area appears on the upper face 34 of filtration plate 6.

FIG. 2 illustrates the same embodiment, in an exploded perspective view and viewed from below, the mounting plate 1, the lower face 12 of which is apparent and includes a recess 13 in which the support carrier 5 is accommodated, is surmounted by the funnel-shaped container 2. In the same way as in FIG. 1, support 4 and the frame of support carrier 3 are illustrated here, for convenience separately whereas support 4 is actually stretched on the frame. The filtration plate 6 includes, on its lower face 33, a cylindrical sleeve 14 which may engage into the mouth of a vacuum manifold not shown.

On the periphery of the filtration unit 1, two pairs 15a, 15b, 16a, 16b of clips appear in FIGS. 1 and 2. The clips of the first pair 15a, 15b of clips are positioned facing each other over the length of the plate 1 and are firmly secured to mounting plate 1. They each comprise a clip fastening tab substantially positioned in the middle of the length of plate 1, firmly secured to plate 1. The supporting prominence or the fixing nib 17a. directed towards the inside of the plate, is located at a determined distance from the lower face 12 of the support plate 1. This distance matches the thickness of the support carrier 5 which overlaps from the recess. Moreover, the clips from the pair of clips 16a, 16b are located, one facing the other, over the width of the mounting plate 1. The clip fastening tabs are firmly secured to the mounting plate 1 and the fixing nibs or supporting prominences 18a, 18b borne by these clip fastening tabs are located at a distance from the lower face 12 of the determined mounting plate, which substantially matches the thickness of the support carrier overlapping from the recess 13 of the mounting plate, added to the thickness of the filtration plate 6.

FIGS. 3 and 4 illustrate in an exploded perspective view, different portions from a device where only the mounting plate 1 the support carrier 3 and a pad carrier plate 7 appear. The pad carrier plate 7 also includes a sleeve 22 substantially positioned on the periphery of the active area, able to be accom-modated on an incubator pad onto which it fits and which is not illustrated here. On the upper surface 19 of the pad carrier plate 7 a circular prominence 20 with a surface substantially equivalent to that of the active area or larger than the latter, is provided. This prominence forms a housing with a slight clip fastening effect into which the pad 23 may engage and be clasped therein.

The thickness of the pad carrier plate 7 is substantially the same as that of the filtration plate 6 so that clips 16a, 16b and their prominences 18a and 18b cooperate with the edges of plate 7 for locking and unlocking the pad carrier plate 7, analogously to the locking and unlocking of the filtration plate 6 as illustrated in FIGS. 1 and 2.

It is apparent both from FIGS. 1, 2 and FIGS. 3, 4 that the support carrier 3 may be locked by the clip fastening tabs 15a, 15b and their supporting prominences 17a, 17b whereas the clip fastening tabs 16a, 16b provide locking and unlocking either of the filtration plate 6 or pad carrier plate 7. When a filtration plate 6 or a pad carrier plate 7 is locked, unlocking the support carrier is inoperative.

Locking and unlocking achieved by the clip pairs 16a, 16b, 15a, 15b operate through the elasticity of the clip fastening tabs. The clip fastening tabs 16a, 16b include extensions 24a, 24b which allow them to be moved. They appear in FIG. 3. When these extensions 24a and 24b are brought closer one to another, for example by manual pressure on clamping, the clip fastening tabs 16a and 16b move away from each other and release the flat element 6 or 7 which they locked.

In the embodiment illustrated in FIGS. 1-4, apertures in the mounting plate 25a, 25b are provided near the clip fastening tabs 15a, 15b. Also in this case, when the mounting plate is clamped, for example with fingers, the nibs 17a, 17b separate from each other and release the support carrier, through elasticity. Release is only possible when no second flat element such as a filtration plate 6 or a pad carrier plate 7 is present.

A mounting plate 1 analogous to that of FIGS. 1-4, a support carrier unit 3 analogous to that of the previous Figs. and a support of the read-out apparatus 8 for receiving the support carrier 3 upon analysis, appear in FIG. 5. The circular read-out support 8 includes a recess 26 of the same shape and thickness as that of the support carrier 3, provided so that the support 4 lands without any lack of flatness, in the center 29 of the read-out support 8; a groove 27 is further provided so as to enable the clip fastening tabs 16 and their supporting prominences 17 to be accommodated upon depositing support carrier 3 on read-out support 8.

A general perspective view of another filtration unit which includes a funnel 102 mounted on a base or mounting plate 101, appears in FIG. 7. A filtration plate 106 is also mounted on mounting plate 101. In this embodiment, clip fastening tabs 116a appear, positioned in the middle of the small side of mounting plate 101 and including nibs 118a and 118b as well as extensions 124a and 124b of which only one is visible. The nib 118a locks the filtration plate 106.

In this figure, the positioning stops 130, 131, 132, 133 are located at the corners of mounting plate 101. These stops allow positioning of the second substantially flat element, here a filtration plate 106 which is inserted between four stops forming a corner. Sleeve 114 which comes into contact with the mouth of the vacuum manifold not shown, appears on the lower face 112 of the filtration plate. Reinforcing plates 135b, 135a which come into contact with positioning stops 130-134 of the filtration plate 106 on the one hand, are positioned over the length of filtration plate 106, and on the other hand they are inserted between the clip fastening tabs 115a (and 115b not shown) of the mounting plate 101. It is thus apparent that the filtration plate 106, through its platelets 135a and 135b, block nibs 117a (and 117b not shown) in the separated position so that nibs 117a and 117b lock the support carrier 103. When they abut against the extension 124a (and 124b not shown) or the clip fastening tabs 116a (and 116b not shown), the nibs 118a, 118b separate and allow the filtration plate 106 to clear from the mounting plate where however the support carrier 103 supported by nibs 115a (and 115b not shown) remains locked.

In this figure, another embodiment of locking and unlocking clips 115 of the support carrier 103 appears other than the one which appears in FIGS. 1-4, nibs 117 are directed outwards. The clip fastening tab 115 and the mounting plate 101 include a slot imparting elasticity to the clip fastening tab 115. Longitudinal and transverse sections of the device of FIG. 7 appear in FIGS. 8 and 9 and 10.

In FIG. 8, funnel 102 appears to be inserted by its lower narrow cylindrical portion 140 inside a sleeve 141 of the mounting plate 101. The clip fastening tabs 116a and 116b positioned on the periphery of the small side of the mounting plate 101 support, through their nibs 118a, 118b, the second flat element which is also a filtration plate 106. Plate 135a appears behind sleeve 141 of the filtration plate and grooves 155a, 155b are provided at the foot of the clip fastening tabs 116a, 116b, so as to give them elasticity when the extensions 124a, 124b are brought closer by clamping.

More specifically, the support carrier 103 and the pad 123 which supports the solid support 104 again appear in FIG. 9 or in FIG. 10.

On the filtration plate, a toric prominence appears positioned on the periphery of the filtration area, on its upper face 143 and which comes into contact with the circular end of container 102 which is not illustrated here au a whole, only its narrow lower portion 140 appears in this figure. Support 104 forms the interface between the end 140 of the funnel and the prominence 142 of the filtration plate, this contact providing leak tightness. Positioning stops 113 of support carrier 103 are located on the lower face 112 of the mounting plate 101. These elements are described in more detail in FIGS. 15-17.

The filtration plate 106 fixed by the mounting plate 101, appears in FIG. 9, wherein the support carrier is itself fixed between mounting plate 101 and filtration plate 106.

In FIG. 10, the details of the making of the clip fastening tabs 115a, 115b of the support carrier 103 appear. The nibs 117a, 117b directed outwards provide locking, as illustrated in the figure, and unlocking of the filtration plate 106 when the nibs, abutting against the external faces of clips 115a and 115b, are pushed through clamping towards the central axis. The apertures 125a, 125b provided in the support carrier 103 let through nibs 117a, 117b. In FIG. 10, slots 136a, 136b appear which through elasticity, allow the clip fastening tabs 115a, 115b to be pushed back towards the central axis through clamping. A stop 146 made at the base and at the periphery of sleeve 141, on its interior surface, guides and supports container 102 and its lower portion 140 upon mounting the funnel 102 in sleeve 141.

Side positioning stops 147a, 147b protruding along the small side of the filtration plate provide locking of the fixing plate 106 by nibs 118a, 118b of mounting plate 101.

FIG. 11a is a detailed view of the end 140 of the funnel 102, illustrated as a section, in FIG. 8. A circular recess 148 is provided on the external surface of the funnel and it engages and cooperates with stop 146 which protrudes at the foot of the sleeve of base plate, not shown. The end of portion 140 of funnel 102 which comes into contact with the filtration support, not shown, exhibits a tapered gadroon seal with an angle α of about 60°. Finally, on the detail of this figure, a circular sealed prominence 150 appears which protrudes and is intended for cooperating with a matching recess 151 provided in the sleeve 141 of the mounting plate, on its internal surface, substantially at the same level.

FIG. 11b illustrates another embodiment of the low end of the funnel. A ring 190 in a material, for example more flexible than that of the funnel, encircles tightly end 140 in a circular recess 148′ and provided on the external surface. Ring 190 may itself have the external profile described in FIG. 11a provided for the lower potion of the funnel, i.e. circular recess 148 and tapered gadroon 149.

This ring forming a seal 190 is preferably secured firmly to the end of the funnel, for example glued or welded. It might be made of polyolefine elastomer, for example ethyle/octene copolymer known as “Angage 8401” by DuPont.

The mounting plate 101 of FIGS. 7-10 bearing the locked support carrier 103, appears in FIG. 12. This is a pad carrier plate 107 which is locked as a flat auxiliary element on base plate 101. A circular sleeve 122 at the periphery of the active area appears on the lower face 211 of the pad carrier plate 107 and is intended for e.g. cooperating with the pad of an incubator not shown. In addition, the sleeve 141 for holding and guiding a container 102 used in an earlier step appears in this figure.

In the same way as with a filtration plate, the pad carrier plate is guided by the positioning stops 130-133 located at the corner of the mounting plate 101. They include, like the filtration plate, positioning stops 177 located on the upper face of the pad carrier plate, along its small side, and with a height matching the distance from the lower face of the mounting plate 101 to the nibs of clips 116, 118a and 118b.

FIGS. 13 and 14 are sectional views of the mounting plate 101 and of its sleeve 140 where clasping prominences 151a, 151b appear for cooperating with the lower portion 140 of funnel 102 and with the toric prominence 150 located on the external surface of this cylindrical portion. The slots 136a, 136b imparting elasticity may also be seen.

The support carrier 103 positioned between positioning stop 113 of the mounting plate 101 also appears in a sectional view. The positioning sleeve 122 on the pad of an incubator not shown also appears in FIG. 13. The positioning stops 177 located on the small side of the pad carrier plate 107 clasped between nibs 118a, 118b and the lower face 112 of the mounting plate 101 appear in FIG. 13.

In FIG. 14, it is apparent that the width of the pad carrier plate 107 is adapted to the distance between the ends of the clip fastening pads 115a, 115b which lock the support carrier 103. It is also apparent that the thickness of the support carrier matches the distance between the lower face 112 of the mounting plate 101 and the nibs 117a and 117b of the clip fastening tabs 115a, 115b.

The mounting plate 101 illustrated in previous FIGS. 7-10 and 12-14 appears in a perspective view, as seen from below and from above, in FIGS. 15, 16 and 17. The sleeve 141 positioned on the upper face of support plate 101 and the fixing clips 116a, 116b as well as their extensions 124a, 124b appear in FIG. 15. On the large side of the mounting plate 101, fixing clips 115a, 115b for locking and unlocking the support carrier appear. Longitudinal slots 136a, 136b provided by recessing the plate, also appear, they enhance the clips' flexibility.

Corner positioning stops 130-133 appear in FIG. 16, on the lower face of the base plate or mounting plate 101 on the one hand as well as positioning stops 113 of the support carrier not shown. Nibs 118a and 118b of clip fastening tabs 116a and 116b also appear in this figure. Notches 137 are provided on both sides of these clip fastening tabs so as to allow for more elasticity during clamping of extensions 124a and 124b.

Nibs 117a, 117b directed outwards appear in FIG. 16.

In the top view illustrated in FIG. 17, the same notches 137 appear on both sides of the clip fastening tabs 118a, 118b as well as the sleeve 141 for guiding the funnel not shown. Slots 136 provided in the mounting plate appear in this view as well as clips 115 linked through side platelets 176 for maintaining the clips 115 slotted on a portion of their height vertically above slot 136, which form bellows.

A perspective view, a top view and a bottom view of a filtration plate 106, as also illustrated in FIGS. 7-10, appear in FIGS. 18, 19 and 20, however without illustrating the filtration area therein. The sleeve 141 is set up around the filtration area, on its lower face 113. Side positioning platelets 135a and 135b and thickness positioning stops 147 which protrude on the upper face also appear and they appear in the top view in FIG. 19. It is on face 143, opposite to lower face 113 of the filtration plate, where protruding positioning stops 186, 187 may be provided with a height substantially equal or slightly larger than that of stops 147. They come and abut against face 112 of the mounting plate. In this embodiment, they are positioned on the axis of symmetry but they may also be positioned somewhere else on surface 143. Such stops are illustrated in FIGS. 9 and 19.

More specifically, FIG. 19 shows the filtration area including grooves 179 on the one hand which allow liquid to spread out during filtration, and on the other hand slots 178 which allow it to cross the filtration area. Thus, slots 178 only appear in the bottom view. The prominence 142 positioned around the filtration area and set up on the upper surface of the filtration plate is provided for receiving a pad on which lies the solid support. The positioning stops of the support carrier may also be present as a pad, rather than a continuous stick 113.

FIGS. 21 and 22 are top and bottom views of a pad carrier plate 107. On its lower face, which appears in FIG. 22, a sleeve or a toric prominence 122 which also appears in FIG. 12, is provided so that the pad carrier plate may be fitted on the pad of an incubator, for example. Stabilization stops 188 and 189 illustrated in FIG. 22 on both sides of sleeve 122, may be provided on the lower face of the pad carrier plate. They preferably protrude with a height substantially greater than that of tabs 118a and 118b and of sleeve 122, as is shown in FIG. 13.

The toric prominence 121 which enables a pad to be positioned appears on the upper face in FIG. 21. The stops for height positioning 177 appear, protruding on this face.

The device including the mounting plate 101 of FIGS. 7 and 18-20 and the support carrier 103 deposited on the read-out support 108 appear in FIG. 23. With the clip fastening tabs 116a and 116b, the pad carrier plate used in a subsequent labelling or activation step may be unlocked. The positioning stops 130-133 have dimensions provided for fitting into the external perimeter of support 108. The clip fastening tabs and their nibs engage and are accommodated in holes 125a-125b with spaces matching the spaces between clips 115.

Frame 105 of the support carrier positioned on the read-out support lo appears in FIG. 24. Slots (125a, 125b) letting the nibs 117 through, also appear. A notch 181 able to cooperate with a pin not shown placed on the read-out support 108 having the function of an orientation foolproof device for frame 105 of the support carrier 103 on the read-out support 108, appears at the corner of support carrier 103.

FIG. 25 is a top view of the frame 105 of support carrier 103 illustrated in the previous figures. Its external dimensions are adapted to the receiving recess of support 108 onto which it is accommodated. In addition to the notch 181, for a more reliable positioning, side positioning stops 182-185 are positioned on the thickness.

It is hereby made reference to FIGS. 27 to 29 for describing an embodiment of a base plate 315 and a pad carrier plate 300 which allow the injection of liquid in the pad, after the mounting of these two plates with the support carrier.

In the embodiment depicted in FIGS. 27 and 28, the pad carrier plate 300 is, as a whole, similar to the pad carrier plate illustrated in FIG. 21. It is essentially rectangular and provided with stops 301 for heigh positioning protruding on its upper face 302. The pad carrier plate 300 comprises, appreciably centred on its upper surface 302, a sleeve 303 delineating an active zone 304, which is preferably circular. This active zone 304 is aimed at receiving a pad.

Preferentially, as illustrated in FIGS. 27 and 28, the active zone 304 is provided with stops 305 (five in the example) intended to maintain the pad in the active zone during and after injection of a liquid.

The heigh of the sleeve 303 and the heigh of the stops 305 are chosen in connection with the pad thickness, in order the upper face of said pad be approximately at the same level as the upper part of the sleeve 303.

The pad carrier plate 300 comprises means for feeding the pad with liquid, or means for injecting a liquid in the pad, which comprises walls 306 and 307 defining a feeding conduit 308.

In this embodiment, two lateral walls 306 are approximately parallel one to the other and essentially vertical, and connected one to the other with an end wall 307, said end wall 307 further comprising an inclined plane 317, the inclination angle β of which, with reference to a vertical axis N, being preferentially in the range extending from about 30° to about 50°, and more preferably equal to about 40°.

The injection or feeding conduit 308 leads to a feeding zone 310 which is in communication with the active zone 304.

The feeding zone 310 is preferably formed as a recess on the upper surface 302 of the pad carrier plate 300. As this recess may lower the mechanical properties of the pad carrier plate 300, at least a portion of the feeding zone 310 may be provided with a reinforcement 312 arranged under said position on the lower face of said plate.

As it appears from FIG. 28, the feeding zone 310 and more especially the recess, is formed as a “fishtail” (roughly having a triangular shape) preferably delineated with walls 318 aimed at cooperating with corresponding part of a support carrier 105 in a liquid proof manner. The fishtail part of the feeding zone (or recess) 310 is preferably continued by an elongated recess part 313.

Due to this feeding zone 310, 313, the liquid which is introduced in the conduit 308 can efficiently feed the pad which is then homogeneously impregnated.

Like the pad carrier plate 107 of FIGS. 21 and 22, the lower face 311 of plate 300 carries a sleeve 314 for fitting said plate 300 on the pad of an incubator, for example.

FIG. 29 is a partial view, of the upper surface of a base plate 315, which is of the same type as those previously described and will therefore not be described in details This base plate 315 comprises a second through aperture 316 which is provided for being positioned in front of the conduit 308 of the pad carrier plate 300, when the support carrier 105 is sandwiched between said pad carrier plate 300 and said base plate 315.

As illustrated in FIG. 25, the support carrier 105 may comprise a recess 316 provided for receiving the walls 318 which delineate the part of the feeding zone 310 which extends between the feeding conduit 308 and the active zone 304.

The walls 318 extend up to the sleeve 303, which comprises an open zone for allowing the liquid to flow into the part of the recess 310 in the active zone.

In the detailed description above, the active area(s) is (are) circular, as well as the matching aperture(s) sleeves(s) and prominences. Of course, other shapes are possible (ovoid, elliptical, rectangular . . . ). Also, the base plate and auxiliary elements have a rectangular shape and are substantially flat. Other shapes are also possible.

1. A mounting device of a support carrier for a device for handling at least one support carrier, said support carrier comprising an active area able to receive a so-called active portion of a support, for contaminants, characterized in that it comprises a base plate comprising:
a through aperture with dimensions substantially identical or larger than the dimensions of said active portion,
a first fixing means for removably fixing said support carrier so that said active portion of the support is positioned facing said aperture on a first side of said base plate, and
a second fixing means for removably fixing an auxiliary element against the face of the support carrier, opposite to said first side of base plate, so that said support carrier is doubly fixed relatively to said base plate.

2. The mounting device according to claim 1, wherein said second fixing means are laid out for placing, together with said auxiliary element, said first means in a locking position precluding any movement of said support carrier.

3. The mounting device according to claim 1, wherein said base plate further includes, on its face opposite to said first side of the base plate, means laid out so as to provide sealed positioning of a container facing said active portion of support.

4. The mounting device according to claim 1, wherein said base plate includes positioning means comprising a sleeve substantially delimiting, on the opposite side of said support, the perimeter of the aperture and including, in a selected location of its internal surface, near the active area, at least a first portion protruding inwards, and/or extends at least partly inside the aperture through a second protruding portion.

5. The mounting device according to claim 4, wherein the first protruding portion is a toric prominence and/or the second protruding portion is substantially circular.

6. The mounting device according to claim 1, wherein the first fixing means comprise at least two plastic clips, substantially positioned facing each other so that they may cooperate with two edges of said support carrier.

7. The mounting device according to claim 1, wherein the second fixing means (16, 116) comprise at least two plastic clips, substantially positioned facing each other so that they may cooperate with two edges of said auxiliary element.

8. The mounting device according to claim 6 or 7, wherein said clips comprise a fixing nib at their free end, wherein the distance between the nib and the surface of the plate facing the nib is substantially equal to the thickness of said auxiliary element and/or of said support carrier.

9. The mounting device according to claim 1, wherein said base plate includes on its lower face positioning stops substantially protruding at the corners of the base plate.

10. The mounting device according to claim 9, wherein the positioning stops of said support carrier are set up or recessed on the lower surface of said plate.

11. The mounting device according to claim 1 wherein it further includes an auxiliary element made up of a substantially flat base with dimensions able to cooperate with said second fixing means.

12. The mounting device according to claim 1 wherein said auxiliary element includes thickness positioning stops which protrude on its upper surface (13).

13. The mounting device according to claim 1, wherein said auxiliary element includes a sleeve and/or a positioning sleeve set up at the active zone, on its lower and/or upper face.

14. The mounting device according to claim 1, wherein said auxiliary element includes positioning stops able to cooperate with said first fixing means of said support carrier.

15. The mounting device according to claim 1, wherein said auxiliary element is provided with a perforated filtration surface with dimensions substantially identical or larger than the dimensions of said active area of said solid support.

16. The mounting device according to claim 1, wherein said auxiliary element is provided on its upper face with a sleeve of dimensions substantially identical to those of said active zone and with a heigh arranged for housing a pad.

17. The mounting device according to claim 16, wherein said auxiliary element includes means for injecting a liquid in said pad.

18. The mounting device according to claim 16, wherein said auxiliary element includes means for injecting liquid in said pad, said means comprising vertical walls delimiting a feeding conduit leading to said active zone, and wherein a through aperture formed in said base plate is provided for being positioned in front of the upper portion of said conduit when said base plate and said auxiliary element are cooperating.

19. The mounting device according to claim 18 wherein at least one of said walls delimiting the feeding conduct comprises an inclined plane with an angle β of about 30° to 50°, particularly 40° related to an axis perpendicular to the surface of said auxiliary element.

20. The mounting device according to claim 1, wherein said auxiliary element bears on its lower face, a positioning sleeve on the pad of an incubator.

21. The mounting device according to claim 13 or 19, wherein the sleeve (s) encircle tightly at least partly.

22. The mounting device according to claim 1, wherein said active zone is substantially circular.

23. A container of a device for handling a support for contaminants comprising a solid support with an active area and a mounting device comprising a base plate with a through aperture and a sleeve around said aperture which comprises an upper portion which forms a tank and a lower portion including an output port with a shape adapted to that of the active area and a recess for cooperating with a portion protruding and forming a stop around said aperture of said base plate.

24. A container according to claim 22, which comprises on the external surface of its tubular lower portion, a positioning prominence cooperating with said sleeve of said base plate.

25. A container according to claim 22, wherein the end of said lower portion includes a tapered toric prominence having an angle of about 60°.

26. A filtration and/or activation unit comprising at least a base plate according to claim 1 and at least one of the selected elements from a support carrier, a container, a filtration plate, a pad carrier plate and a lid.

27. Process for treating a contaminant of a sample, said contaminant being fixed or deposited on a support comprising a lower surface, wherein the contaminant is incubated or labelled by contacting of a pad fed with nutrients and/or labelling solution with said lower surface or said support, in which said pad is fed with said nutients or labelling solution after placing said inferior surface on said pad.
